(19) United States
(12) Patent Application Publication
(10) Pub. No.: US 2024/0303820 A1
(43) Pub. Date: Sep. 12, 2024

(54) INFORMATION PROCESSING APPARATUS, INFORMATION PROCESSING METHOD, AND COMPUTER-READABLE RECORDING MEDIUM

(71) Applicant: NEC Corporation, Tokyo (JP)

(72) Inventor: Youki SADA, Tokyo (JP)

(73) Assignee: NEC Corporation, Tokyo (JP)

(21) Appl. No.: 18/586,847

(22) Filed: Feb. 26, 2024

(30) Foreign Application Priority Data
Mar. 8, 2023 (JP) 2023-035664

(51) Int. Cl. G06T 7/11; G06T 5/70; G06V 10/771

(52) U.S. Cl. CPC G06T 7/11; G06T 5/70; G06V 10/771; G06T 2207/20182

(57) ABSTRACT

An image processing apparatus including: a first mask generation unit that generates a first mask based on a difference between a first frame image and a second frame image, or a difference between a first output feature map that is output from a first convolutional layer for processing the first frame image and a second output feature map that is output from a first convolutional layer of a second convolutional neural network for processing the second frame image; a second mask generation unit that generates a second mask for each of resolutions used in convolutional layers of the second convolutional neural network, based on the first mask and each of the resolutions; and a second mask distribution unit that distributes the second mask to the convolutional layers of the second convolutional neural network, based on the resolutions used in the convolutional layers of the second convolutional neural network.

### CROSS-REFERENCE TO RELATED APPLICATION

This application is based upon and claims the benefit of priority from Japanese patent application No. 2023-035664, filed on Mar. 8, 2023, the disclosure of which is incorporated herein in its entirety by reference.

### BACKGROUND OF THE INVENTION

### 1. Field of the Invention

The present disclosure relates to an image processing apparatus that uses a neural network, an image processing method, and a computer-readable recording medium.

### 2. Background Art

Models for recognizing behavior of a target object in a moving image use neural networks (NN) in order to perform processing such as object recognition and pose estimation, for example. Here, the neural networks require a huge amount of computation, and it is therefore inefficient to execute processing such as object recognition and pose estimation for each frame image.

Sparse neural networks have been proposed as a method for reducing the amount of computation in the neural networks. A sparse neural network reduces the amount of computation in convolutional layers by performing computation only for differences (regions with a difference: important regions) between two consecutive frames. Specifically, in a sparse neural network, a mask for hiding regions other than the important region (i.e. regions with no difference between frames: non-important region) is generated every time computation is performed in a convolutional layer, and the amount of computation is reduced by performing computation for only the important region using the generated mask.

Non-Patent Documents 1 and 2 disclose related techniques, namely activation sparse neural networks that use differences. Non-Patent Document 1 discloses DeltaCNN (Convolutional Neural Networks) that applies a mask to an input feature map. Non-Patent Document 2 discloses Skip-Convolutions, in which a mask is applied to an output feature map.

For Non-Patent Document 1, see “Mathias Parger, Chengcheng Tang, Christopher D. Twigg, Cem Keskin, Robert Wang, Markus Steinberger, “DeltaCNN: End-to-End CNN Inference of Sparse Frame Differences in Videos”, Proceedings of the IEEE/CVF Conference on Computer Vision and Pattern Recognition. 2022, [online], Submitted on 8 Mar. 2022, arXiv Computer Science>Computer Vision and Pattern Recognition, [searched on Feb. 6, 2023], Internet<URL:https://arxiv.org/abs/2203.03996>”. For Non-Patent Document 2, see “Amirhossein Habibian Davide Abati Taco S. Cohen Babak Ehteshami Bejnordi, “Skip-Convolutions for Efficient Video Processing”, Proceedings of the IEEE/CVF Conference on Computer Vision and Pattern Recognition. 2021, [online], Submitted on 23 Apr. 2021, arXiv Computer Science>Computer Vision and Pattern Recognition, [Searched on Feb. 6, 2023], Internet<URL:https://arxiv.org/abs/2104.11487>”.

However, with the above techniques, a mask is generated for each convolutional layer, and overhead occurs due to the generation of the mask. That is, when regenerating a mask, difference processing, threshold processing, or the like is executed, resulting in a decrease in execution speed. Further, index calculation or the like is required every time a mask is regenerated. Moreover, the mask is different for each convolutional layer, and it is therefore necessary to collect the important regions again.

In DeltaCNN of Non-Patent Document 1, the influence of the important regions increases as the number of layers increases, and thus, the important regions need to be regenerated after each convolution process. In Skip-Convolutions of Non-Patent Document 2, the number of important regions does not monotonically increase, but the mask is regenerated, thus causing overhead.

### SUMMARY OF THE INVENTION

One example of an object of the present disclosure is to reduce the amount of computation in a neural network.

In order to achieve the example object described above, an image processing apparatus according to an example aspect includes:
a first mask generation unit that generates a first mask based on a difference between a first frame image and a second frame image, or a difference between a first output feature map that is output from a first convolutional layer of a first convolutional neural network for processing the first frame image and a second output feature map that is output from a first convolutional layer of a second convolutional neural network for processing the second frame image;
a second mask generation unit that generates a second mask for each of resolutions used in convolutional layers of the second convolutional neural network, based on the first mask and each of the resolutions; and
a second mask distribution unit that distributes the second mask to the convolutional layers of the second convolutional neural network, based on the resolutions used in the convolutional layers of the second convolutional neural network.

Also, in order to achieve the example object described above, an image processing method according to an example aspect for a computer to carry out:
generating a first mask based on a difference between a first frame image and a second frame image, or a difference between a first output feature map that is output from a first convolutional layer of a first convolutional neural network for processing the first frame image and a second output feature map that is output from a first convolutional layer of a second convolutional neural network for processing the second frame image;
generating a second mask for each of resolutions used in convolutional layers of the second convolutional neural network, based on the first mask and each of the resolutions; and
distributing the second mask to the convolutional layers of the second convolutional neural network, based on the resolutions used in the convolutional layers of the second convolutional neural network.

Furthermore, in order to achieve the example object described above, a computer-readable recording medium according to an example aspect includes a program recorded on the computer-readable recording medium, the program including instructions that cause the computer to carry out:
generating a first mask based on a difference between a first frame image and a second frame image, or a difference between a first output feature map that is output from a first convolutional layer of a first convolutional neural network for processing the first frame image and a second output feature map that is output from a first convolutional layer of a second convolutional neural network for processing the second frame image;
generating a second mask for each of resolutions used in convolutional layers of the second convolutional neural network, based on the first mask and each of the resolutions; and
distributing the second mask to the convolutional layers of the second convolutional neural network, based on the resolutions used in the convolutional layers of the second convolutional neural network.

As described above, according to the present disclosure, the amount of computation in a neural network can be reduced.

### BRIEF DESCRIPTION OF THE DRAWINGS

FIG. 1 is a diagram for illustrating operation of a convolutional neural network (CNN).

FIG. 2 is a diagram for illustrating operation of a sparse CNN (SCNN).

FIG. 3 is a diagram for illustrating an example of an image processing apparatus 100.

FIG. 4 is a diagram for illustrating an example of an image processing apparatus 100a.

FIG. 5 is a diagram for illustrating an example of a system that includes the image processing apparatus 100.

FIG. 6 is a diagram for illustrating an example of a system that includes the image processing apparatus 100a.

FIG. 7 is a diagram for illustrating an example of the operation of the image processing apparatus.

FIG. 8 is a diagram illustrating an example of a computer that realizes the image processing apparatus in the example embodiments.

### EXEMPLARY EMBODIMENT

Firstly, an overview is provided to facilitate understanding of the following embodiment.

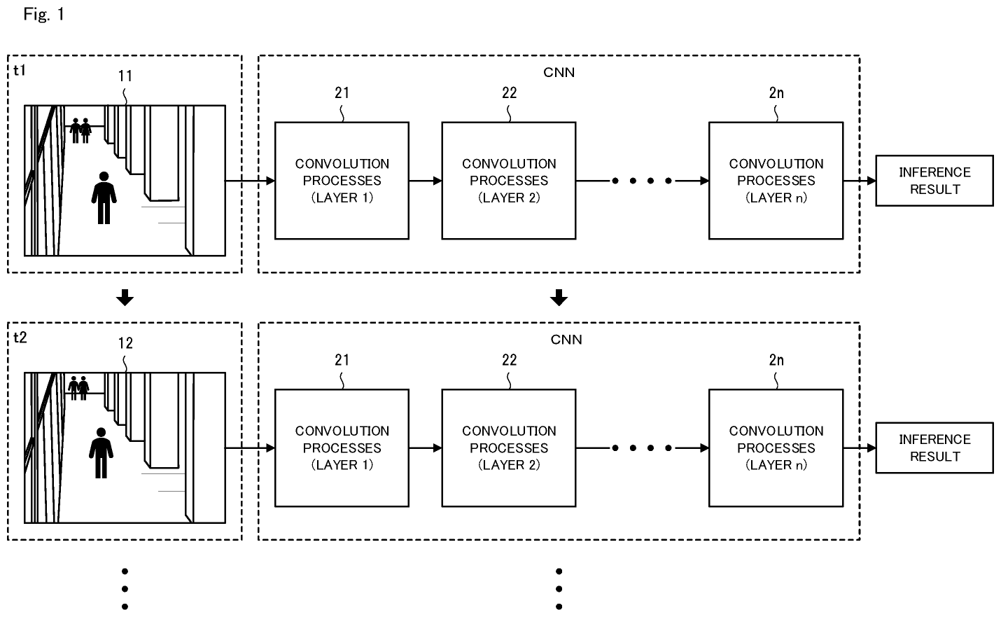

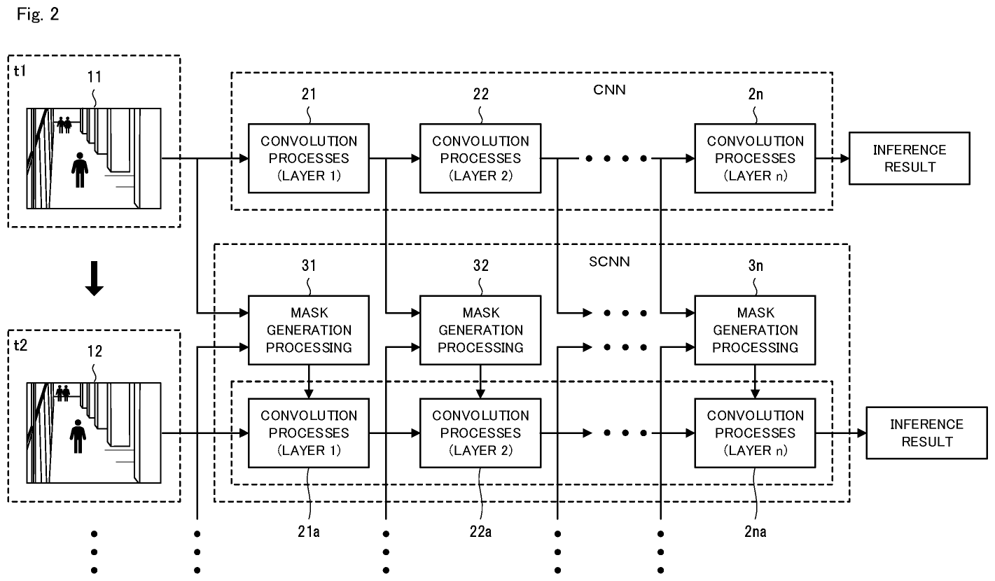

FIG. 1 is a diagram for illustrating operation of a convolutional neural network (CNN). FIG. 2 is a diagram for illustrating operation of a sparse CNN (SCNN).

Behavior recognition processing using a CNN is described.

In the behavior recognition processing using the CNN shown in FIG. 1, every time a frame image is acquired, the acquired frame image is input to a model for performing behavior recognition processing (processing including object recognition processing, pose estimation processing etc.), and the result (inference result) of the behavior recognition processing is obtained. In the example in FIG. 1, when a frame image 11 is acquired at time t1 and the acquired frame image 11 is input to the CNN, convolution processes 21 to 2n is sequentially executed, and the result of the behavior recognition processing for the frame image 11 is obtained. Note that n is an integer of 2 or more.

Also, when a frame image 12 is acquired at time t2 (time after the time t1) and the acquired frame image 12 is input to the CNN, the convolution processes 21 to 2n is sequentially executed, and the result of the behavior recognition processing is obtained from the frame image 12.

However, since the behavior recognition processing is executed for each frame image, the amount of computation is huge and the processing is inefficient. For example, pose estimation processing alone requires 100 million or more times of sum-of-products operation for one frame image.

Behavior recognition processing using a SCNN is described.

In the behavior recognition processing using the SCNN shown in FIG. 2, a frame image 11 is acquired at time t1, the acquired frame image 11 is input to the model, and convolution processes 21 to 2n is sequentially executed.

Next, when a frame image 12 is acquired at time t2 (time after time t1), a difference between the frame image 11 and the frame image 12 is detected through mask generation processing 31, and a mask is generated based on the difference.

The difference is information representing a difference between pixel values of a pixel at the same position in the frame image 11 and the frame image 12. The mask is information representing portions that have changed between the frame image 11 and the frame image 12 (differences: important regions) and portions that have not changed (non-important regions). Note that the mask is applied to frame images after time t2 and output feature maps of convolutional layers.

Next, in the convolution process 21a, the generated mask is applied to the frame image 12 acquired at time t2, and the convolution process is executed only for the important regions. Note that the amount of computation can be reduced since the processing result of the convolution process 21 is used for the non-important regions. Thereafter, in the convolution process 21a, an output feature map of a first layer (information input into the convolution process 22a: input feature map of a second layer) is generated using the result of processing performed on the important regions and the non-important regions.

Further, in mask generation processing 32 to 3n and convolution processes 22a to 2na, the same processing as the above-described mask generation processing 31 and convolution process 21a is sequentially executed. Also, for frame images acquired after time t2, processing is executed as described above for each of the frame images.

However, the SCNN is inefficient since mask processing is executed for each of the convolutional layers for each frame image acquired at time t2 onward. Specifically, in the mask processing, difference processing, threshold processing, or the like is executed, which significantly degrades the execution speed.

Further, index calculation or the like is required every time a mask is regenerated. The “index” refers to an index of a spatial position of the important regions ({(x1, y1), (x2, y2), . . . , (xn, yn)}). xi is an x-coordinate of an important region of an i-th pixel, and yi is a y-coordinate of the important region of the i-th pixel. In addition, in the index calculation, the index is referenced to select a correct weight parameter when multiplying the important region by the weight parameter. Moreover, the mask is different for each convolutional layer, and it is therefore necessary to collect important regions again. Accordingly, the amount of computation is also huge with the SCNN, which is inefficient.

Through the above process, the inventor discovered the problem that the amount of computation with the SCNN could not be reduced by the above method, and also derived a means to solve this problem.

That is, the inventor derived a means for reducing the amount of computation in the mask processing. As a result, the amount of computation with the SCNN can be reduced.

An embodiment is described below with reference to the drawings. In the drawings described below, elements having the same or corresponding functions are denoted by the same reference numerals, and repeated description thereof may be omitted.

Embodiment

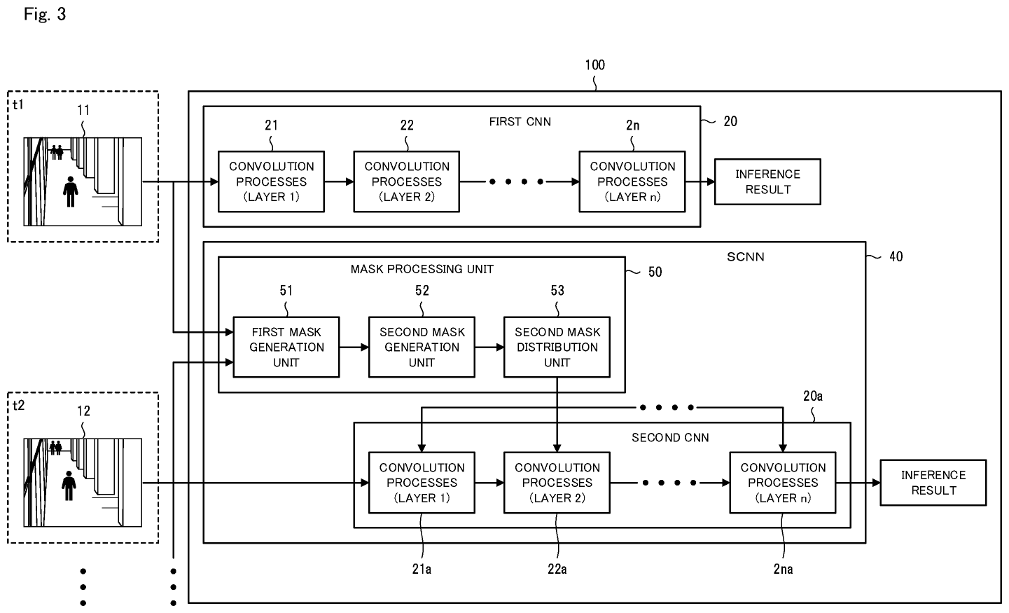

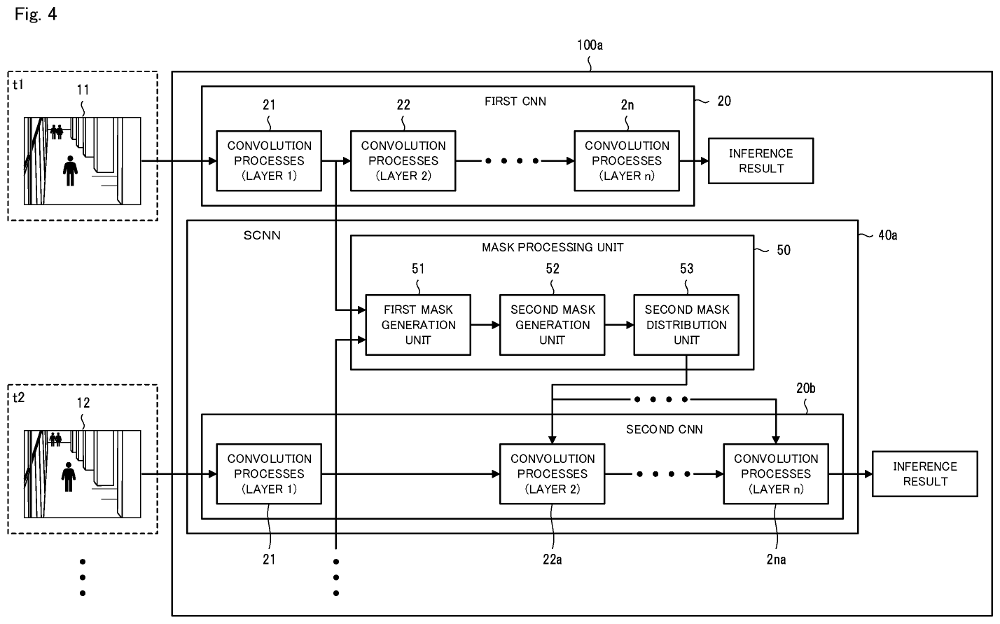

A configuration of an image processing apparatus according to an embodiment is described with reference to FIGS. 3 and 4. FIG. 3 is a diagram for illustrating an example of an image processing apparatus 100. FIG. 4 is a diagram for illustrating an example of an image processing apparatus 100a.

Apparatus configuration

The image processing apparatuses 100 and 100a shown in FIGS. 3 and 4, respectively, are apparatuses that can reduce the amount of computation in a neural network. The image processing apparatus 100 shown in FIG. 3 has a first CNN 20 and an SCNN 40. The SCNN 40 has a mask processing unit 50 and a second CNN 20a. The image processing apparatus 100a shown in FIG. 4 has a first CNN 20 and an SCNN 40a. The SCNN 40a has a mask processing unit 50 and a second CNN 20b.

The image processing apparatus 100 (example in FIG. 3) is described.

Upon acquiring a frame image 11 at time t1, the first CNN 20 sequentially executes convolution processes 21 to 2n, and outputs an inference result for the frame image 11 (first frame image). Note that n is an integer of 2 or more. Although only the convolution processes 21 to 2n is shown in the example in FIG. 3, the first CNN 20 also has layers such as a pooling layer in reality.

The mask processing unit 50 has a first mask generation unit 51, a second mask generation unit 52, and a second mask distribution unit 53. As shown in FIG. 3, the first mask generation unit 51 generates a first mask based on a difference between the frame image 11 acquired at time t1 and a frame image 12 (second frame image) acquired at time t2.

The second mask generation unit 52 generates a second mask for each resolution, based on the first mask and the resolution used in each of the convolutional layers of the second CNN 20a.

The second mask distribution unit 53 distributes the second mask to the convolutional layers of the second CNN 20a, based on the resolutions used in the convolutional layers of the second CNN 20a.

The second CNN 20a in the example in FIG. 3, sequentially executes the convolution processes 21a to 2na only for the important regions while applying the second mask, and outputs an inference result for the frame image 12 (second frame image). Note that n is an integer of 2 or more. Although only the convolution processes 21a to 2na are shown in the example in FIG. 3, the second CNN 20a also has layers such as a pooling layer in reality.

For frame images acquired after time t2 as well, the second mask is generated and processing is executed as described above using the currently acquired frame image and the previously acquired frame image.

The image processing apparatus 100a (example in FIG. 4) is described.

Upon acquiring a frame image 11 at time t1, the first CNN 20 sequentially executes convolution processes 21 to 2n, and outputs an inference result for the frame image 11 (first frame image). Note that n is an integer of 2 or more. Although only the convolution processes 21 to 2n are shown in the example in FIG. 4, the first CNN 20 also has layers such as a pooling layer in reality.

As shown in FIG. 4, the first mask generation unit 51 generates a first mask based on a difference between a first output feature map that is output from a first layer of the first CNN 20 corresponding to the frame image 11 and a second output feature map that is output from a first layer of the second CNN 20b corresponding to the frame image 12.

The second CNN 20b in the example in FIG. 4 first executes the convolution process 21 in which the second mask is not applied. Thereafter, the second CNN 20b sequentially executes the convolution processes 22a to 2na only for the important region while applying the second mask, and outputs an inference result for the frame image 12 (second frame image). Note that n is an integer of 2 or more. Although only the convolution processes 21, 22a to 2na are shown in the example in FIG. 4, the second CNN 20b also has layers such as a pooling layer in reality.

For frame images acquired after time t2 as well, the second mask is generated and processing is executed as described above using the currently acquired frame image and the previously acquired frame image.

As described above, in the embodiment, the second mask is shared by a plurality of convolutional layers, and it is therefore possible to reduce the number of times of the mask generation processing, which has been conventionally performed for each convolutional layer. That is, overhead occurring due to the mask generation processing can be reduced. Accordingly, the amount of computation with the SCNN can be reduced.

System configuration

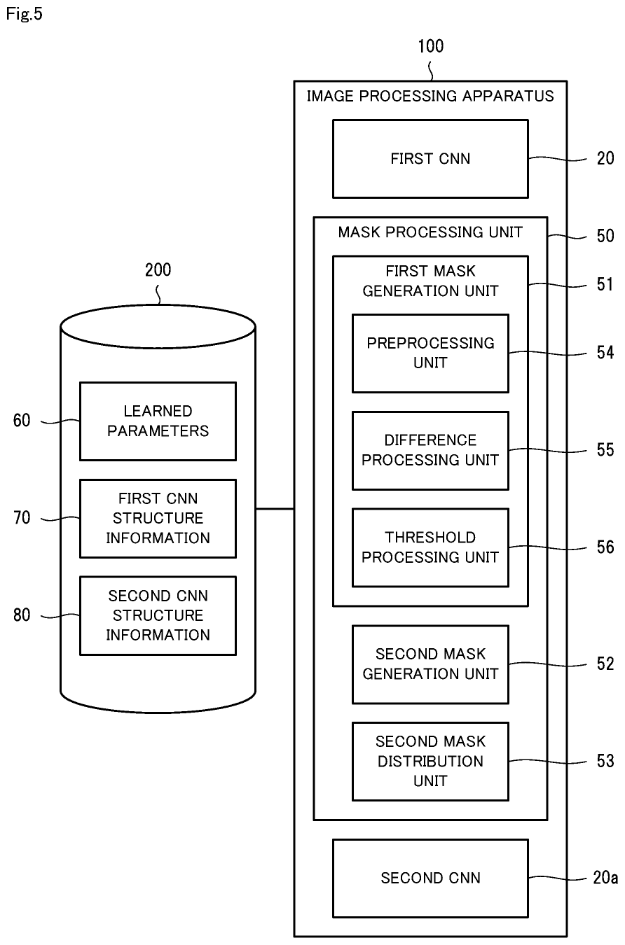

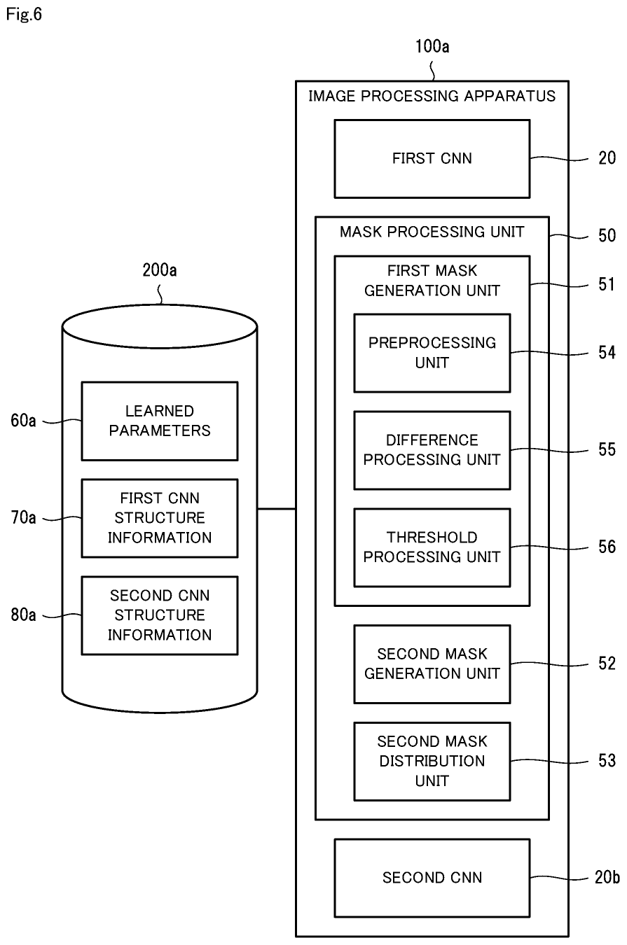

The configuration of the image processing apparatuses according to the embodiment is described in more detail with reference to FIGS. 5 and 6. FIG. 5 shows an example of a system that includes the image processing apparatus 100. FIG. 6 shows an example of a system that includes the image processing apparatus 100a.

The system shown in FIG. 5 includes the image processing apparatus 100 and a storage device 200. Note that the image processing apparatus 100 and the storage device 200 are connected by a network. The system shown in FIG. 6 includes the image processing apparatus 100a and a storage device 200a. Note that the image processing apparatus 100a and the storage device 200a are connected by a network.

The network refers to a general network constructed using a communication channel such as the Internet, a LAN (Local Area Network), a dedicated line, a telephone line, a corporate network, a mobile communication network, Bluetooth (registered trademark), or WiFi (wireless Fidelity).

Each of the image processing apparatuses 100 and 100a is, for example, an information processing device such as a CPU (central Processing Unit), a programmable device such as an FPGA (Field-Programmable Gate Array), a GPU (Graphics Processing Unit), a circuit equipped with one or more of these units, a server computer, a personal computer, or a mobile terminal.

Note that the image processing apparatus 100 has the first CNN 20, the mask processing unit 50, and the second CNN 20a. The first CNN 20 and the second CNN 20a have already been described and descriptions thereof is omitted.

The image processing apparatus 100a has the first CNN 20, the mask processing unit 50, and the second CNN 20b. The first CNN 20 and the second CNN 20b have already been described and descriptions thereof is omitted.

Each of the storage devices 200 and 200a is a database, a server computer, a circuit with a memory, or the like.

In the storage device 200 in FIG. 5, at least learned parameters 60 of the first CNN 20 and the second CNN 20a, first CNN structure information 70 representing a structure of the first CNN 20, and second CNN structure information 80 representing a structure of the second CNN 20a are stored. Although the storage device 200 is provided outside the image processing apparatus 100 in the example in FIG. 5, the storage device 200 may alternatively be provided within the image processing apparatus 100. The storage device 200 may alternatively be constituted by a plurality of storage devices.

In the storage device 200a in FIG. 6, at least learned parameters 60a of the first CNN 20 and the second CNN 20b, first CNN structure information 70a representing a structure of the first CNN 20, and second CNN structure information 80a representing a structure of the second CNN 20b are stored. Although the storage device 200a is provided outside the image processing apparatus 100a in the example in FIG. 6, the storage device 200a may alternatively be provided within the image processing apparatus 100a. The storage device 200a may alternatively be constituted by a plurality of storage devices.

The mask processing unit 50 has a first mask generation unit 51, a second mask generation unit 52, and a second mask distribution unit 53. The first mask generation unit 51 has a preprocessing unit 54, a difference processing unit 55, and a threshold processing unit 56.

The first mask generation unit 51 is described.

The preprocessing unit 54 removes noise from the first frame image and the second frame image, or from the first output feature map and the second output feature map.

In the case of the image processing apparatus 100, the preprocessing unit 54 first acquires the first frame image and the second frame image. Next, the preprocessing unit 54 executes blurring processing using a smoothing filter on the first frame image and the second frame image.

In the case of the image processing apparatus 100a, the preprocessing unit 54 first acquires the first output feature map and the second output feature map. Next, the preprocessing unit 54 executes blurring processing using a smoothing filter on the first output feature map and the second output feature map.

Examples of the smoothing filter include an averaging filter, a Gaussian filter, a median filter, and a minimum value filter. However, the blurring processing is not limited to processing using a smoothing filter, and may be any processing through which noise can be removed.

Next, the preprocessing unit 54 outputs, to the difference processing unit 55, the first frame image and the second frame image that have been subjected to the blurring processing, or the first output feature map and the second output feature map that have been subjected to the blurring processing.

The difference processing unit 55 detects a difference between the first frame image and the second frame image that have been subjected to the blurring processing. In the example in FIGS. 3 and 5, the difference processing unit 55 first acquires the first frame image and the second frame image that have been subjected to the blurring processing. Next, the difference processing unit 55 detects a difference between the first frame image and the second frame image that have been subjected to the blurring processing. Next, the difference processing unit 55 outputs the detected difference to the threshold processing unit 56.

The difference between the first frame image and the second frame image that have been subjected to the blurring processing is information (e.g. an integer of 0 or more in the case of an absolute difference) representing a difference between pixel values of each pixel at the same position in the first frame image and the second frame image that have been subjected to the blurring processing.

Alternatively, the difference processing unit 55 detects a difference between the first output feature map and the second output feature map that have been subjected to the blurring processing. In the example in FIGS. 4 and 6, the difference processing unit 55 first acquires the first output feature map and the second output feature map that have been subjected to the blurring processing. Next, the difference processing unit 55 detects a difference between the first output feature map and the second output feature map that have been subjected to the blurring processing. Next, the difference processing unit 55 outputs the detected difference to the threshold processing unit 56.

The difference between the first output feature map and the second output feature map that have been subjected to the blurring processing is information (e.g. an integer of 0 or more in the case of an absolute difference) representing a difference between pixel values of each pixel at the same position in the first output feature map and the second output feature map that have been subjected to the blurring processing.

The threshold processing unit 56 compares the detected difference with a preset threshold and determines whether or not the pixel has changed. Specifically, the threshold processing unit 56 first acquires the detected difference. Next, the threshold processing unit 56 determines whether or not the detected difference is greater than or equal to the threshold. Next, the threshold processing unit 56 generates a first mask in which a pixel corresponding to the difference greater than or equal to the threshold is set as an important region, and a pixel corresponding to the difference smaller than the threshold is set as a non-important region.

The second mask generation unit 52 is described.

The second mask generation unit 52 generates a second mask for each resolution, based on the first mask and each of the resolutions used in the second CNN 20a or the second CNN 20b.

Specifically, the second mask generation unit 52 first acquires the resolution of each input feature map used in the second CNN 20a or the second CNN 20b. The resolution is information representing the height, width, and the like of the input feature map. Note that the resolution is acquired from the second CNN structure information 80 or 80a, for example.

Next, the second mask generation unit 52 executes pooling processing on the first mask based on the height and width corresponding to each of the acquired resolutions, and generates a plurality of second masks corresponding to the resolutions. The pooling processing uses, for example, max pooling, average pooling, or the like.

Variation

In a variation, the second mask generation unit 52 generates the second mask based on a changed resolution every time the resolution used in the convolutional layers changes. That is, instead of generating the second mask for each resolution at a time, the second mask may be generated based on a changed resolution every time the resolution changes.

The second mask distribution unit 53 is described.

Based on the resolutions, the second mask distribution unit 53 distributes the second mask to the convolution processes 21a to 2na in the second CNN 20a or the convolution processes 22a to 2na in the second CNN 20b.

Apparatus operation

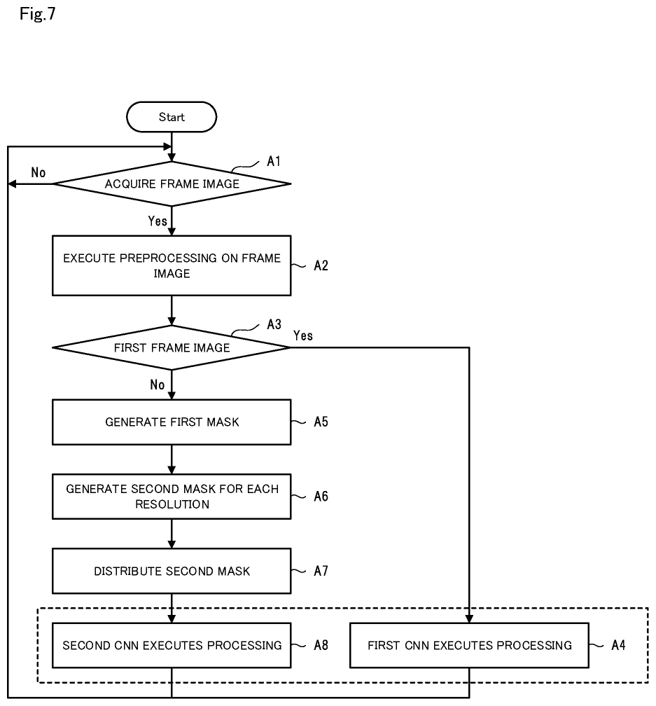

Next, the operation of the image processing apparatus according to the embodiment is described with reference to FIG. 7. FIG. 7 is a diagram for illustrating an example of the operation of the image processing apparatus. The diagrams are referenced as appropriate in the following description. In the embodiment, an image processing method is performed by operating the image processing apparatus. Therefore, the following description of the operation of the image processing apparatus replaces the description of the image processing method according to the embodiment.

As shown in FIG. 7, if the image processing apparatus 100 or 100a acquires a frame image (step A1: Yes), the image processing apparatus 100 or 100a performs preprocessing on the frame image. Here, the preprocessing is, for example, processing such as frame cutting, resizing, color conversion, image cutting, and rotation (step A2). If the image processing apparatus 100 or 100a has not acquired a frame image (step A1: No), the image processing apparatus 100 or 100a waits for a frame image to be input.

Next, if the frame image acquired by the image processing apparatus 100 or 100a is the first frame image (step A3: Yes), the first CNN 20 executes processing (step A4).

If the frame image acquired by the image processing apparatus 100 or 100a is the second frame image (step A3: No), the first mask generation unit 51 generates the first mask based on a difference between the first frame image and the second frame image (step A5).

Specifically, in step A5, the preprocessing unit 54 first removes noise from the first frame image and the second frame image, or from the first output feature map and the second output feature map.

In the case of the image processing apparatus 100, the preprocessing unit 54 first acquires the first frame image and the second frame image. Next, in step A5, the preprocessing unit 54 executes blurring processing using a smoothing filter on the first frame image and the second frame image. Next, in step A5, the preprocessing unit 54 outputs, to the difference processing unit 55, the first frame image and the second frame image that have been subjected to the blurring processing.

In the case of the image processing apparatus 100a, the preprocessing unit 54 first acquires the first output feature map and the second output feature map. Next, in step A5, the preprocessing unit 54 executes blurring processing using a smoothing filter on the first output feature map and the second output feature map. Next, in step A5, the preprocessing unit 54 outputs, to the difference processing unit 55, the first output feature map and the second output feature map that have been subjected to the blurring processing.

Next, in step A5, the difference processing unit 55 detects a difference between the first frame image and the second frame image that have been subjected to the blurring processing.

In the case of the image processing apparatus 100, the difference processing unit 55 first acquires the first frame image and the second frame image that have been subjected to the blurring processing. Next, the difference processing unit 55 detects a difference between the first frame image and the second frame image that have been subjected to the blurring processing. Next, the difference processing unit 55 outputs the detected difference to the threshold processing unit 56.

In the case of the image processing apparatus 100a, the difference processing unit 55 first acquires the first output feature map and the second output feature map that have been subjected to the blurring processing. Next, the difference processing unit 55 detects a difference between the first output feature map and the second output feature map that have been subjected to the blurring processing. Next, the difference processing unit 55 outputs the detected difference to the threshold processing unit 56.

Next, in step A5, the threshold processing unit 56 compares the detected difference with a preset threshold and determines whether or not the pixel has changed.

Specifically, the threshold processing unit 56 first acquires the detected difference. Next, the threshold processing unit 56 determines whether or not the detected difference is greater than or equal to the threshold. Next, the threshold processing unit 56 generates a first mask in which pixels corresponding to the difference greater than or equal to the threshold are each set as an important region, and pixels corresponding to the difference smaller than the threshold are each set as a non-important region.

Next, the second mask generation unit 52 generates the second mask for each resolution, based on the first mask and the resolution used in each of the convolutional layers of the second CNN 20a (step A6).

Specifically, in step A6, the second mask generation unit 52 first acquires the resolution of each of the input feature maps used in the second CNN 20a or the second CNN 20b.

Next, in step A6, the second mask generation unit 52 performs pooling processing on the first mask based on the height and width corresponding to each of the acquired resolutions, and generates a plurality of second masks corresponding to the resolutions.

Next, the second mask distribution unit 53 distributes the second mask to the convolutional layers of the second CNN 20a based on the resolutions used in the convolutional layers of the second CNN 20a (step A7).

Specifically, in step A7, the second mask distribution unit 53 distributes, based on the resolutions, the second mask to the convolution processes 21a to 2na in the second CNN 20a or the convolution processes 22a to 2na in the second CNN 20b.

Next, in the case of the image processing apparatus 100, of the image processing apparatuses 100 and 100a, the second CNN 20a executes processing. In the case of the image processing apparatus 100a, the second CNN 20b executes processing (step A8).

Thus, the image processing apparatus 100 or 100a repeatedly executes processing in steps A1 to A8.

Effects of Embodiment

As described above, according to the embodiment, the second mask is shared by a plurality of convolutional layers, and it is therefore possible to reduce the number of times of the mask generation processing, which has been conventionally executed for each convolutional layer. That is, overhead occurring due to the mask generation processing can be reduced. Accordingly, the amount of computation with the SCNN can be reduced.

Program

The program according to the example embodiment may be a program that causes a computer to execute steps A1 to A8 shown in FIG. 7. By installing this program in a computer and executing the program, the image processing apparatus and the image processing method according to the example embodiment can be realized. Further, the processor of the computer performs processing to function as the first CNN 20, the mask processing unit 50 (the first mask generation unit 51 (the preprocessing unit 54, a difference processing unit 55, and a threshold processing unit 56), the second mask generation unit 52 and the second mask distribution unit 53) and the second CNN 20a (or the second CNN 20a or 20b).

Also, the program according to the example embodiment may be executed by a computer system constructed by a plurality of computers. In this case, for example, each computer may function as any of the first CNN 20, the mask processing unit 50 (the first mask generation unit 51 (the preprocessing unit 54, a difference processing unit 55, and a threshold processing unit 56), the second mask generation unit 52 and the second mask distribution unit 53) and the second CNN 20a (or the second CNN 20a or 20b).

Physical Configuration

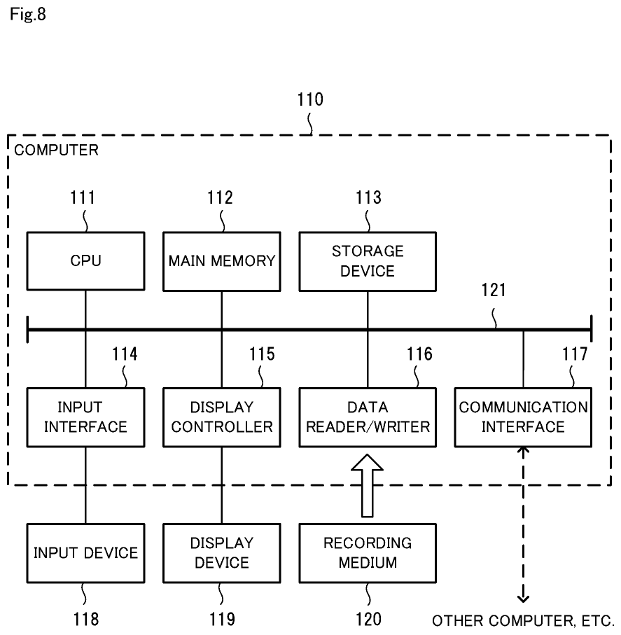

Here, a computer that realizes an image processing apparatus by executing the program according to the example embodiment will be described with reference to FIG. 8. FIG. 8 is a diagram illustrating an example of a computer that realizes the image processing apparatus in the example embodiments.

As shown in FIG. 8, a computer 110 includes a CPU 111, a main memory 112, a storage device 113, an input interface 114, a display controller 115, a data reader/writer 116, and a communication interface 117. These units are connected via bus 121 so as to be able to perform data communication with each other. Note that the computer 110 may include a GPU or a FPGA in addition to the CPU 111 or instead of the CPU 111.

The CPU 111 loads a program (codes) according to the first and second example embodiments and the first and second working examples stored in the storage device 113 to the main memory 112, and executes them in a predetermined order to perform various kinds of calculations. The main memory 112 is typically a volatile storage device such as a DRAM (Dynamic Random Access Memory).

Also, the program according to the first and second example embodiments and the first and second working examples are provided in the state of being stored in a computer-readable recording medium 120. Note that the program according to the first and second example embodiments and the first and second working examples may be distributed on the Internet that is connected via the communication interface 117.

Specific examples of the storage device 113 include a hard disk drive, and a semiconductor storage device such as a flash memory. The input interface 114 mediates data transmission between the CPU 111 and the input device 118 such as a keyboard or a mouse. The display controller 115 is connected to a display device 119, and controls the display of the display device 119.

The data reader/writer 116 mediates data transmission between the CPU 111 and the recording medium 120, and reads out the program from the recording medium 120 and writes the results of processing performed in the computer 110 to the recording medium 120. The communication interface 117 mediates data transmission between the CPU 111 and another computer.

Specific examples of the recording medium 120 include general-purpose semiconductor storage devices such as a CF (Compact Flash (registered trademark)) and a SD (Secure Digital), a magnetic recording medium such as a flexible disk, and an optical recording medium such as a CD-ROM (Compact Disk Read Only Memory).

The image processing apparatus 100 and 100a according to the example embodiment can also be achieved using hardware corresponding to the components, instead of a computer in which a program is installed. Furthermore, a part of the image processing apparatus 100 and 100a may be realized by a program and the remaining part may be realized by hardware. In the example embodiment, the computer is not limited to the computer shown in FIG. 8.

Although the invention has been described with reference to the embodiments, the invention is not limited to the example embodiment described above. Various changes can be made to the configuration and details of the invention that can be understood by a person skilled in the art within the scope of the invention.

According to the technology described above, the amount of calculation of the convolutional neural network can be reduced. In addition, it is useful in a field where the convolutional neural network is required.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

What is claimed is:

1. An image processing apparatus comprising:
at least one memory storing instructions; and
at least one processor configured to execute the instructions to:
generate a first mask based on a difference between a first frame image and a second frame image, or a difference between a first output feature map that is output from a first convolutional layer of a first convolutional neural network for processing the first frame image and a second output feature map that is output from a first convolutional layer of a second convolutional neural network for processing the second frame image;
generate a second mask for each of resolutions used in convolutional layers of the second convolutional neural network, based on the first mask and each of the resolutions; and
distribute the second mask to the convolutional layers of the second convolutional neural network, based on the resolutions used in the convolutional layers of the second convolutional neural network.

2. The image processing apparatus according to claim 1,
wherein the at least one processor is further configured to execute the instructions to:
generate the second mask by executing pooling processing on the first mask.

3. The image processing apparatus according to claim 1,
wherein the at least one processor is further configured to execute the instructions to:
every time a resolution used in the convolutional layers changes, generate the second mask based on the changed resolution.

4. The image processing apparatus according to claim 1, further comprising:
wherein the at least one processor is further configured to execute the instructions to:
remove noise by executing blurring processing on the first frame image and the second frame image, or on the first output feature map and the second output feature map.

5. An image processing method in which a computer executes:
generating a first mask based on a difference between a first frame image and a second frame image, or a difference between a first output feature map that is output from a first convolutional layer of a first convolutional neural network for processing the first frame image and a second output feature map that is output from a first convolutional layer of a second convolutional neural network for processing the second frame image;
generating a second mask for each of resolutions used in convolutional layers of the second convolutional neural network, based on the first mask and each of the resolutions; and
distributing the second mask to the convolutional layers of the second convolutional neural network, based on the resolutions used in the convolutional layers of the second convolutional neural network.

6. A non-transitory computer readable recording medium that includes a program recorded thereon, the program including instructions that cause a computer to carry out:
generating a first mask based on a difference between a first frame image and a second frame image, or a difference between a first output feature map that is output from a first convolutional layer of a first convolutional neural network for processing the first frame image and a second output feature map that is output from a first convolutional layer of a second convolutional neural network for processing the second frame image;
generating a second mask for each of resolutions used in convolutional layers of the second convolutional neural network, based on the first mask and each of the resolutions; and
distributing the second mask to the convolutional layers of the second convolutional neural network, based on the resolutions used in the convolutional layers of the second convolutional neural network.

7. The non-transitory computer readable recording medium according to claim 6,
wherein the second mask generation, the second mask is generated by executing pooling processing on the first mask.

8. The non-transitory computer readable recording medium according to claim 6,
wherein the second mask generation, every time a resolution used in the convolutional layers changes, the second mask is generated based on the changed resolution.

9. The non-transitory computer readable recording medium according to claim 6, wherein the program further includes instructions that cause the computer to carry out:
removing noise by executing blurring processing on the first frame image and the second frame image, or on the first output feature map and the second output feature map.
